(19) United States
(12) Patent Application Publication
(10) Pub. No.: US 2006/0149616 A1
(43) Pub. Date: Jul. 6, 2006

(54) Systems and methods for forecasting book demand

(76) Inventor: Peter G. Hildick-Smith, New York, NY (US)

Correspondence Address: LADAS & PARRY, 26 WEST 61ST STREET, NEW YORK, NY, 10023, US

(21) Appl. No.: 11/030,725

(22) Filed: Jan. 5, 2005

(51) Int. Cl. G06F 17/30

(52) U.S. Cl. 705/10

(57) ABSTRACT

Systems and methods for forecasting demand for a test book. One method according to the present invention includes dividing books into a plurality of categories with each of the categories having a unifying concept, developing a demand forecast model for each category by selecting a plurality of variables and, for each category, assigning each selected variable a value based upon historical data showing the importance of each selected variable in predicting demand for books in the category. The test book is assigned to one of the plurality of categories based upon a similarity between the test book and the unifying concept of the assigned category. A target audience is provided with the test book and the audience is surveyed to capture data that can be used to calculate a forecasted value for each selected variable in the assigned category. The forecasted value is then used for each selected variable in the demand forecast model for the assigned category to forecast a demand for the test book. Another method according to the invention includes providing and surveying the target audience with all or part of the full text of the test book.

### FIELD OF THE INVENTION

The invention relates to methods, systems, and computer program instructions for modeling and forecasting individual book market demand in the book publishing industry, enabling demand-based book publishing and demand-based book retailing.

### BACKGROUND OF THE INVENTION

The US book publishing industry introduced over 160,000 new titles to market in calendar year 2003 (Source: RR Bowker, Books In Print), with 14% introduced by the 10 largest book publishers, accounting for roughly 50% of total sales. The balance of new books was produced by the 60,000 other publishers currently operating in the US. The industry is one of the most prolific producers of new products in the US marketplace today, and is critically dependent on this very large yearly new item flow to generate up to 70% of annual revenues.

This very significant annual output of published books is culled by individual publishers, editors, agents, book packagers, retail merchants, and buyers—from a much larger pool of book proposals, manuscripts, and other submissions—who then must decide what will be published and sold in the market. The decision to publish a work is currently based on the decision-maker's personal industry experience, intuition, judgment, and “taste”. The work's sales estimate is typically based on the actual market sales performance of previously published books with a comparable topic or theme. Its income potential is then calculated and balanced against the costs of acquiring, licensing, marketing, producing, and distributing the proposed book. This comparable title pro forma P&L (estimated Profit and Loss Statement) approach is the standard practice in the book publishing industry today.

In spite of the very significant number of unique new titles published each year, the consumer book industry has flat to declining overall sales, a declining audience base (down 14% since 1992), with an estimated 90% of these newly published books failing to fulfill their P&L goals. Because of consistently overly optimistic forecasting and production, on average 40% of all book units produced and shipped to retailers remain unsold and are returned to the publisher at significant cost. With increasing competition from other, newer forms of entertainment and education media, the book industry must increasingly rely on creating new “hits” to fuel growth. As a result, competition for major existing and new literary talent has increased the royalty advances paid to writers based on projected new-book sales. When an expected “hit” book fails to meet or exceed the projected/budgeted sales volume goal that the royalty advance is set against, the cost of the advance is written off, creating a further significant cost burden on the publisher. Book retailers are also negatively affected by the publisher's inability to efficiently select project, prioritize and distribute new books. The retailer must incur the cost of stocking and returning a huge volume of new books annually. With 40% of bookstore inventory never generating sales revenue, costly selling space, which could have supported a book with strong retail customer appeal, is blocked from generating revenue. As a result, retailers' critical sales/square foot productivity and key financial performance metric is reduced, thereby penalizing the retailer in the financial markets. The retailer is thus forced to operate at sub-standard efficiency due to the lack of management information to correctly guide the selection and merchandising of customer preferred items at store level.

In sum, most of the key business performance drivers of the book publishing industry, from new-book selection and acquisition, to royalty advance and book production levels, to retail purchasing and merchandising, are critically dependent on being able to accurately forecast an individual book's market demand, and resulting sales. However, the industry's current methods of forecasting book demand are clearly not consistently effective at either selecting or forecasting the sales potential of financially successful new books for publication. An improved method for forecasting new-book demand is needed if the industry is to grow sales and profitability in the face of ever-increasing competition from alternative entertainment and education media.

The objective of demand forecasting is to measure the prospective purchase level of a product at any time before it is released to market. The primary goal is either to aid in deciding the correct resource allocation or investment level that a new offering should receive, or to help identify the presentation, variation, or draft of a given product or product idea with the greatest demand opportunity, or both.

The challenge of consistently identifying, improving and forecasting successful new business opportunities is at the core of all product development endeavors. As a result, this has been a focus of effort in a wide range of industries, from motion pictures and software to breakfast cereal and credit cards. A wide body of knowledge and a range of effective strategies and tools have been developed to address this fundamental new business development issue. These solutions have historically been developed to improve the success rate and reduce investment risk in industries—such as automobiles and foods—that launch only a limited number of major new products annually, not tens of thousands, as in the book industry. These high-investment/high-risk industries, each requiring multi-million dollar/multi-year initial investments to participate, survive and compete, easily cost-justify significant R&D and demand forecasting expense. As a result, demand forecasting has gone beyond a competitive advantage to becoming a business-development survival necessity. However, in book publishing, the short shelf life and modest revenue scale of an individual book (typically much less than $1 million), combined with the huge number of titles released annually, has made it technically and economically unfeasible to adopt demand-based publishing strategies to date.

Given the inefficiency of today's book publishing industry and its total reliance on an “experience” based decision process, there is a significant need for improved forecasting systems and methods that can strengthen the book industry's overall market relevance and business performance.

An object of this invention is to address the central issues of product-development efficiency and profitability uniquely faced by the book publishing industry. The invention provides systems and methods that are sufficiently timely, low cost, and high capacity to meet the process, financial, and product output requirements of the book publishing industry. A system or method according to the invention can be used to significantly improve decision-making at virtually any stage in the book development, publishing and retailing process.

### SUMMARY OF THE INVENTION

For the purpose of the invention, it is understood that a “test book” is an individual work or idea that may be a new book proposal, transcript, new book concept, previously published book, re-print, imported book, or book going from an existing format to an alternative format (e.g. from hardcover to paperback).

In one embodiment of the invention, there is provided a method for forecasting demand for a test book, including dividing books into a plurality of categories, with each of the categories having a unifying concept. A demand forecast model is developed for each of the plurality of categories by selecting a plurality of variables. For each category, each of the selected variables is assigned a value based upon previously derived weightings that quantify the influence of each of the selected variables in predicting demand for books in the category. The test book is assigned to one of the plurality of categories based upon a similarity between the test book and the unifying concept of the assigned category. A target audience is then provided with the test book and that audience is surveyed to capture data that can be used to calculate a forecasted value for each of the selected variables in the assigned category. The forecasted value for each of the selected variables is then used in the demand forecast model for the assigned category to forecast a demand for the test book.

The method may also include gathering sales data for a published book for which demand has been forecast according to the demand forecast model in the assigned one of the plurality of categories, and comparing the demand forecast of the published book against the demand forecast of the test book.

In accordance with another aspect of the invention, the method may also include calibrating the demand forecast model by adjusting the weighting of each of the selected variables in the assigned one of the plurality of categories, based on their impact on the gathered sales data of the published book.

In another embodiment of the invention, there is provided a system for forecasting demand for a test book.

In yet another embodiment of the invention, there is provided a machine-readable medium that stores sequences of processor instructions for forecasting demand for a test book.

### BRIEF DESCRIPTION OF THE DRAWING

The foregoing and other objects, aspects, and advantages of the invention will be better understood from the following detailed description with reference to the drawing, in which:

FIG. 1 is a flowchart of a forecasting method according to the invention.

### DETAILED DESCRIPTION OF THE PREFERRED EMBODIMENTS

Systems and methods according to the invention provide not only book-specific demand measurement on a pre-publication basis, but can do so quickly, efficiently, inexpensively, and in sufficient volume to be economically highly advantageous to book publishers and retailers. Such systems and methods consolidate all major demand-impact components of a book, anywhere from the initial idea to the finished book stage, into a single-page “concept”. This concept is quantitatively evaluated, typically within a range of other new-book concepts, through a survey process that measures prospective-buyer purchase intent and other key demand influencers. This information is then combined with other critical distribution, marketing, publicity, and retail merchandising plan data into book-category-specific forecasting models. These statistical models determine either demand relative to other books in the category, or absolute demand in the form of volumetric forecasts. The findings can be used to identify the best book development opportunities as part of an overall book publishing or retailing program. Decision making can be improved at any stage in the book-development process from the evaluation of initial ideas, concepts, proposals or categories, through individual book refinement and enhancement, and ultimately to production, retail selection, and merchandising.

A demand forecasting method according to one embodiment of the invention has five major components: suppliers, inputs, process, output, and customer. “Suppliers” provide the necessary data and executional support for the method to take place. The “inputs” are the essential stimuli, dimensions, and measurements required to assess test-book demand and create a forecast. The “process” defines the way in which the inputs are combined, presented, measured, analyzed, assessed, and reported. The “output” is the final assessment of a book's relative or absolute market demand. The “customer” is the end-user or beneficiary of the demand information, such as a book publisher, who is typically involved in or responsible for a given publishing investment decision.

As to suppliers, those preferred for demand measurement according to the invention include the author, agent, editor, designer, packager, publisher, distributor, club, retailer, or team responsible for preparing and providing the prospective book's concept material. Such material includes all art, copy, and related information, as well as book categorization and comparative benchmark titles already in market. The sales, marketing, publicity, operations, supply chain, or finance-business functions can also provide the key measures of target category existing-book sales performance, inventory availability, media exposure, advertising reach, units of distribution, points of distribution, level of merchandising support, and other critical awareness and demand inputs. Target audience members can be supplied through retail customer lists, market research panels, or from the broader marketplace, and are identified, supplied, contacted, screened, surveyed, and rewarded based on the medium and through the relationship in which they are most efficiently reached, including mail, internet, central location, mall intercept, telephone, etc. The forecaster typically provides the test design, survey content and scripting, programming, formatting, fielding, data measurement, analysis, and results presentation. Once the test book is published, actual market sales information to track, assess, and improve forecast model accuracy is provided through the book's publisher, participating retailers, or retail sales monitoring services.

Regarding inputs, the actual net sales for a new book are typically the end result of the marketplace's direct response to the interaction of six major factors: (1) concept/content, (2) target audience, (3) book awareness, (4) book demand, (5) book availability, and (6) actual in-market book sales performance. Each of these input factors must be accurately quantified at the individual title level to forecast a book's sales and sales potential effectively. The demand forecast process collects quantitative information on all six critical factors and integrates them into category-specific models that appropriately weight their relative impact on total sales and then generate a demand forecast.

The book concept is the combination of all the essential presentation elements of the test book. The book concept typically includes the title, author's name, author information, descriptive copy, suggested retail price, cover graphics, and statements of advanced praise or review. It is most easily presented in single page summary format. The content can be a table of contents, a representative book chapter, full manuscript, advance reading copy, or the final book's full text, depending on the level of development of the book or book idea. It provides the prospective consumer with a direct reading experience of the test book.

The target audience is the population of “end-consumers” or purchase influencers most receptive to purchasing and/or recommending a book in a specific category. The audience can be defined by end-consumer demographics, purchasing role, book-category loyalty, and prior purchasing or reading behavior. The end-consumer audience can include readers, purchasers, general consumers, parents, children, teachers, librarians, professors, managers, purchasing agents, trainers or administrators. The potential audience for each specific title must be sized accurately to arrive at a meaningful forecast. Since books with higher market demand may appeal to both category-specific and general book shoppers, but at significantly different rates, measurement of both audiences is preferred. Audience size information is obtained through survey and/or retail-purchase information at the customer level.

Awareness of a book's existence is measured as the percent of the target audience that will potentially become aware of the book's existence in the marketplace. It is built through a range of sources, retail presence, merchandising level and visibility, number of impressions delivered through media publicity, Internet exposure and advertising reach. The prospective book's marketing, sales, and publicity plans can provide the necessary quantification of awareness potential. In many book categories, the prospective audience's prior knowledge of and commitment to a given author is also a critical awareness factor that is also measured.

Purchase demand for a specific book is measured as the target audience's level of intent to actually purchase and/or read that book. It is primarily captured through the aware audience's response to the book or the test book concept. It is rated for overall interest and purchase intent. Additional demand initiators include the author's prior reputation and personal recommendations, which are also measured through survey response. Longer-term demand potential can be more comprehensively measured by providing audience members with rough manuscript or final book text content to read, in part or in full. Post-read purchase intention and recommendation intention information can then be captured and included into the forecasting model's overall demand assessment.

Availability for a book is measured by its physical availability for purchase by its prospective audience at their moment of peak awareness and demand. It is a direct result of the book's production size and inventory availability, combined with its level of distribution to “shelf stock” in those points of purchase (retail stores, Internet sellers, book clubs, etc.) most relevant and accessible to that aware, demand-motivated audience at the time when awareness and purchase intent have been established. If the book is physically unavailable for purchase, no amount of audience awareness or demand potential can result in actual sales volume.

In-market performance is determined by the book's actual sales to the end consumer once it has been published and introduced to the overall market. For books sold through retail channels this would be the book's net retail sales, for books sold through other channels this would be the final, unreturned sales to the end consumer. This information is critical to confirm the book forecast's accuracy, and to update and calibrate the forecast model to continuously improve its predictive accuracy.

Systems and methods according to the invention, or portions of such systems and methods, may be implemented using the Internet and/or other communication networks. For example, a system according to the invention may comprise, and a method according to the invention may be performed at a server device connected to a network.

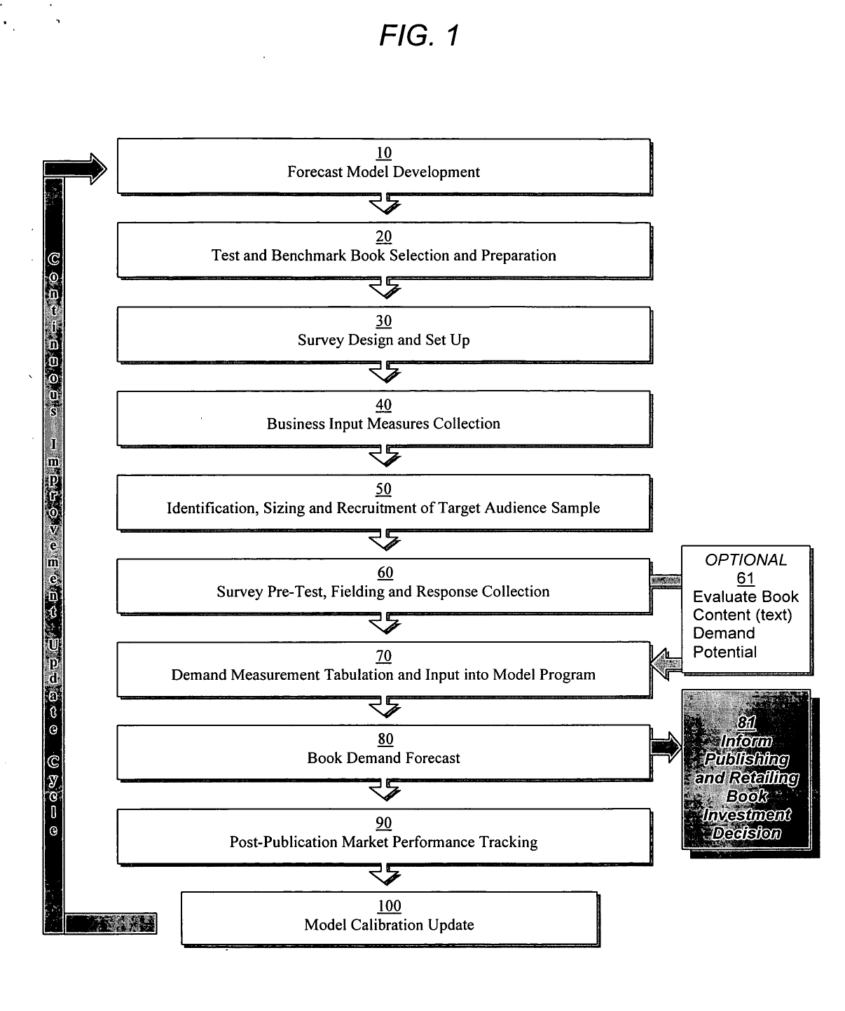

FIG. 1 shows the overall steps of a preferred forecasting method, which generally includes: forecast model development (block 10); test and benchmark book-concept selection and preparation (block 20); survey design and setup (block 30); business input measures collection (block 40); identification, sizing, and recruitment of target audience sample (block 50); survey pre-test, fielding, and response collection (block 60); optional evaluation of book content (text) demand potential (block 61); demand measurement tabulation and input into model program (block 70); book demand forecast (block 80); informing publishing and retailing book investment decision (block 81); post-publication market performance tracking (block 90); and model calibration update (block 100).

The book industry covers the full range of human endeavor in the non-fiction form, and the furthest reaches of the human imagination in the fiction form. As a result, the diversity of content, usage needs, reading behavior and target audiences is significantly broader than in most other industries. Consequently, each individual book category has to have its own separate forecasting models and benchmarks based on its unique stimulus/response function as determined by the relative impacts of the inputs outlined above. Given the extensive diversity of book categories across all genres, formats and target groups, each category model is uniquely developed in the forecast model development (block 10) using statistical analysis to assign appropriate weightings to each independent variable necessary to solve for the dependent variable of retail unit sales, or other demand objective metric. The critical independent variables for each test-book concept may include the prospective consumer's purchase intent, author perception, recommendation level, distribution, merchandising support, promotional and publicity support, and other key audience, awareness, demand, and availability factors unique to the potential presentation and delivery of the concept book to market. Models are validated and calibrated by comparing forecasted net demand versus actual demand achieved on previously published benchmark books to reduce the time required for the model development process. Independent variable influence weightings are adjusted to improve model fit. Additional critical independent variables may also be added to improve the model. More specific book category definitions and models typically provide more accurate forecasts. The 40-50 discrete book categories, as commonly defined by book retailers and known to those skilled in the art (such as those used by Amazon.com, Barnes & Noble, Borders, or the BISAC categories), may be used to provide effective industry segmentation for demand model development and forecasting in methods and systems according to the invention. The books in the same category typically have a unifying concept (e.g., common theme, focus, or topic area).

As shown in block 20, test books can be selected based on any rough book idea, proposal, manuscript in process, multiple concept variations for one specific book, completed book, or at any development point in between where either absolute or relative demand information is needed to make a publishing or investment decision. Benchmark books (i.e., previously published books with known unit sales), also should be selected from the same book category as the test book. Preferably, the book's category is confirmed by analyzing a preliminary survey of consumer respondents' own categorization of the test book rather than relying on operator judgment. The benchmark books serve both as performance controls to help calibrate or refine the forecasting model and as direct competitive performance indicators, providing a ranking perspective to help identify development issues and opportunities for the test books. Preferably, at least two benchmark books are selected for each test book, and all key concept components from the book or book idea are consolidated into a single page format to be embedded in the survey.

A concept test survey is designed (as shown in block 30) to capture end-consumer respondent data in four areas: (1) respondent categorization information on age, gender, education level, income, and any specific characteristics relevant to the book concept's usage (e.g., presence of children under five years old at home for a children's picture book); (2) respondent prior category purchase information; (3) concept purchase intent and related component evaluation; and (4) author equity information. Additional concept diagnostic information may also be collected to help further improve concept demand potential. Retail shopping behavior may also be collected to better target retail distribution and support. Concept exposure may be either in monadic, sequential monadic, or trade-off formats. To achieve maximum sample cost efficiency, larger selections of concepts—preferably at least 50—should be included in the survey in direct trade-off or “browsing” format.

In block 40, business input measures are then collected, if necessary. Business input measures may include sales distribution level and channel plans, publicity event type and size, marketing and merchandising spending plans, and the related level and incremental sales impact of store merchandising support. All such measures must be defined, quantified, and collected to populate the model to complete a volume forecast. If only relative demand rankings are needed, then this business input information is not required.

In block 50, the target audience sample is identified, sized, and recruited. The survey respondent group must ensure a meaningful representation of frequent end-consumers across all major book-purchasing channels being tested, including traditional retail and Internet outlet types. Sample size must be adequate to have stable readings for each individual concept tested at both the general and category-specific end-consumer-segment level for all key demographic groups.

Once the target audience sample is identified, sized, and recruited, the concept test survey is fielded, as shown in block 60. This can be achieved by using any of the traditional market-research channels known in the art. However, given the Internet's speed and efficiency, and the very low incidence rates of purchasing in many book categories, it is a very effective channel for fielding the demand survey and reaching the required audiences quickly and efficiently. In addition, automated online survey software provides self-coded responses that can be summarized automatically in real time. Sample composition can be tracked instantly during fielding to ensure an adequate balance and representation of all key respondent characteristics both demographic and categorical. Each survey preferably should be pre-tested before full fielding using a small sample of target respondents to ensure it meets clarity, data collection, and completion-time requirements.

Optionally, the book content demand potential is also evaluated, at block 61, to provide a longer-term demand assessment. While the key elements driving initial demand through a book's first four to eight weeks after publication are very substantially captured in the test book concept and related support method, the full extent of a book's demand potential over its entire lifecycle is best measured by including an assessment of its full content, or at least a significant chapter. This added measurement is most important if the book's content is judged likely to significantly exceed book-consumer expectations, in turn generating greatly increased word of mouth, and resulting in much higher ongoing sales past the initial selling period. This effect is most likely to occur with less-known authors or with topics that are less familiar to the heavy-book-purchasing audience.

Once all survey responses have been completed to meet the sample quotas, the response data is input into a statistical analysis program, at block 70, to tabulate responses and extract the concept-specific measures needed to populate the category model being used to forecast the book's demand. If relative demand is the goal, this data is then ranked against the category benchmark book concepts to determine relative potential against known book properties with proven sales. If a volumetric forecast is the goal, the data is loaded into the relevant model to calculate the forecast.

In block 80, the typical sales demand horizon for a test-book-concept-only forecast is eight weeks; shorter or longer periods may also be forecast. Content-based forecasts (including book text) can effectively predict significantly longer sales horizons. Preferably, the demand is shown through a relative ranking of competing test and benchmark books in the same category in terms of potential audience size, or as a proportion of the audience expressing high commitment to purchase. The demand may also be expressed in terms of units or dollar sales; whichever will most efficiently aid the book publishing or investment decision should be used.

The model chosen must match the category of the test book. This is best confirmed by analyzing the respondent's own categorization of the book concept, rather than relying on judgment. The forecast models vary widely owing to the unique size of each target-category audience, the unique weightings of the related awareness and demand-independent variables of and the weightings' significantly different effect on the demand forecast outcome. Forecasts are fine-tuned based on ongoing calibration with the most current category-benchmark concepts tested. Volumetric results may be derived for units, dollars (or any other currency), or other financial metrics, including Net Present Value (NPV), Internal Rate of Return (IRR), breakeven period, etc.

The customers of the book demand forecast, typically the publishing or retailing decision-makers (e.g., authors, agents, and anyone in a key decision-making function at a packager, publisher, or retailer, including investors, management, and personnel involved in editorial, finance, publishing, sales, production, operations, supply chain, purchasing, category management, or merchandising) who must determine the most productive investment of capital or resources in a book publishing or retailing program, will then be informed of the forecast, as shown in block 81. The customer will be able to utilize the demand forecast to make publishing and investment decisions, as well as decisions concerning the choice to develop, write, acquire, license, edit, improve, design, sell, promote, market, advertise, publicize, print, distribute, stock, or merchandise at any point during the book publishing process. Points in such a process may include: assessing a book idea; assessing a book proposal based on the book idea; acquiring the rights to a book based on the book proposal; determining resource support for the book; developing and refining the book; setting sales and budget priority for the book; directing the sell-in to retailers, agreeing on publicity level for the book; determining print quantities; publishing and distributing the book; and displaying and promoting the book.

To ensure forecast validity and to continuously improve process performance and accuracy, each book's actual post-publication net retail sell-through volume is tracked, at block 90, over the forecast period. Any additional market or other exogenous effects must be identified, measured and analyzed to upgrade and further enhance each model's ability to capture, explain and most accurately project going forward.

Each category model requires multiple cycles of concept testing, validation, and re-calibration to reach its full forecasting potential. As newer retail channels or awareness media evolve and become common practice in the industry (e.g., Internet reviews, retailing, and promotion), each model must be adjusted to account for these changes in the specific category demand and purchase dynamics.

As skilled artisans will recognize, the steps in FIG. 1 may be implemented in a computer-based system.

A computer-based system according to the present invention may include any type of hardware known to those of skill in the art—from personal digital assistants to mainframe computers, on a single machine or on multiple machines (such as in a client-server environment)—and any type of software known to those of skill in the art. One example of such a system includes a personal computer and spreadsheet software (such as Microsoft Excel).

The scope of the present invention is defined by the claims and is not to be limited by the specific embodiments and examples described in this specification. Various modifications of the invention in addition to those described will be apparent to those skilled in the art from the foregoing description and accompanying figures. Such modifications are intended to come within the scope of the claims.

I claim:

1: A method for forecasting demand for a test book comprising:
(a) dividing books into a plurality of categories with each of the categories having a unifying concept;
(b) developing a demand forecast model for each category by selecting a plurality of variables and, for each category, assigning to each selected variable a value based upon historical data showing the importance of each selected variable in predicting demand for books in that category;
(c) assigning the test book to one of the categories based upon a similarity between the test book and the unifying concept of the assigned category;
(d) providing a target audience with the test book and surveying the audience to capture data that can be used to calculate a forecasted value for each selected variable in the assigned category; and
(e) using the forecasted value for each selected variable in the demand forecast model for the assigned category to forecast a demand for the test book.

2: The method as claimed in claim 1, wherein the variables are selected from the group consisting of a prospective consumer's purchase intent, author perception, recommendation level, distribution, merchandising support, promotional and publicity support, key audience, awareness, demand, and availability.

3: The method as claimed in claim 1, further comprising:
(a) gathering sales data for a published book for which demand had been forecast according to the demand forecast model in the assigned category, and
(b) comparing the demand forecast of the published book with the demand forecast of the test book.

4: The method as claimed in claim 3, further comprising calibrating the demand forecast model for each selected variable in the assigned category based on the gathered sales data of the published book.

5: The method as claimed in claim 1, wherein the step of assigning the test book to a book category comprises designing and fielding a survey.

6: The method as claimed in claim 1, wherein the surveying is conducted over the Internet.

7: The method as claimed in claim 1, wherein the surveying is conducted using survey software.

8: The method as claimed in claim 1, further comprising providing the target audience with all or part of the full text of the test book and surveying the target audience.

9: The method as claimed in claim 1, wherein the variables comprise business input measures, and the method further comprises collecting business input measures and inputting the business input measures into the demand forecast model for the assigned category.

10: The method as claimed in claim 9, wherein the business input measures are selected from the group consisting of sales distribution level and channel plans, publicity event type and size, marketing and merchandising spending plans and the related level and incremental sales impact of store merchandising support.

11: The method as claimed in claim 1, wherein the demand forecast of the test book is expressed in terms of unit sales.

12: The method as claimed in claim 1, wherein the demand forecast of the test book is expressed in terms of dollar sales.

13: The method as claimed in claim 1, further comprising utilizing the forecasted demand for the test book to make a demand-based publishing decision.

14: The method as claimed in claim 1, further comprising utilizing the forecasted demand for the test book to make a demand-based retailing decision.

15: A system for forecasting demand for a test book comprising:
(a) means for dividing books into a plurality of categories with each of the categories having a unifying concept;
(b) means for developing a demand forecast model for each category by selecting a plurality of variables and, for each category, assigning to each selected variable a value based upon historical data showing the importance of each selected variable in predicting demand for books in that category;
(c) means for assigning the test book to one of the categories based upon a similarity between the test book and the unifying concept of the assigned category;
(d) means for providing a target audience with the test book and surveying the audience to capture data that can be used to calculate a forecasted value for each selected variable in the assigned category; and
(e) means for using the forecasted value for each selected variable in the demand forecast model for the assigned category to forecast a demand for the test book.

16: The system as claimed in claim 15, wherein the variables are selected from the group consisting of a prospective consumer's purchase intent, author perception, recommendation level, distribution, merchandising support, promotional and publicity support, key audience, awareness, demand, and availability.

17: The system as claimed in claim 15, further comprising:
(a) means for gathering sales data for a published book for which demand had been forecast according to the demand forecast model in the assigned category, and
(b) means for comparing the demand forecast of the published book with the demand forecast of the test book.

18: The system as claimed in claim 17, further comprising means for calibrating the demand forecast model for each selected variable in the assigned category based on the gathered sales data of the published book.

19: The system as claimed in claim 15, wherein the means for assigning the test book to a book category comprises means for designing and fielding a survey.

20: The system as claimed in claim 15, wherein the surveying is conducted over the Internet.

21: The system as claimed in claim 15, wherein the surveying is conducted using survey software.

22: The system as claimed in claim 15, further comprising means for providing the target audience with all or part of the full text of the test book and surveying the target audience.

23: The system as claimed in claim 15, wherein the variables comprise business input measures, and the system further comprises means for collecting business input measures and means for inputting the business input measures into the demand forecast model for the assigned category.

24: The system as claimed in claim 23, wherein the business input measures are selected from the group consisting of sales distribution level and channel plans, publicity event type and size, marketing and merchandising spending plans and the related level and incremental sales impact of store merchandising support.

25: The system as claimed in claim 15, wherein the demand forecast of the test book is expressed in terms of unit sales.

26: The system as claimed in claim 15, wherein the demand forecast of the test book is expressed in terms of dollar sales.

27: The system as claimed in claim 15, further comprising means for utilizing the forecasted demand of the test book to make a demand-based publishing decision.

28: The system as claimed in claim 15, further comprising means for utilizing the forecasted demand of the test book to make a demand-based retailing decision.

29: A machine-readable medium having stored thereon sequences of instructions, which when executed by a processor cause an electronic system to:
(a) divide books into a plurality of categories with each of the categories having a unifying concept;
(f) develop a demand forecast model for each category by selecting a plurality of variables and, for each category, assigning to each selected variable a value based upon historical data showing the importance of each selected variable in predicting demand for books in that category;
(g) assign the test book to one of the categories based upon a similarity between the test book and the unifying concept of the assigned category;
(h) provide a target audience with the test book and survey the audience to capture data that can be used to calculate a forecasted value for each selected variable in the assigned category; and
(i) use the forecasted value for each selected variable in the demand forecast model for the assigned category to forecast a demand for the test book.
